(19) United States
(12) Patent Application Publication
(10) Pub. No.: US 2026/0328653 A1
(43) Pub. Date: Oct. 22, 2026

(54) ACCELERATED TEST DEVICE AND USE METHOD FOR ACCURACY RETENTIVITY OF MACHINE TOOL ROTATION AXIS COMPONENTS

(71) Applicants: DALIAN UNIVERSITY OF TECHNOLOGY, Dalian (CN); LONGCHENG LABORATORY OF INTELLIGENT MANUFACTURING, Changzhou (CN)

(72) Inventors: Kuo LIU, Dalian (CN); Chujie WU, Dalian (CN); Jiapeng XING, Dalian (CN); Di ZHAO, Dalian (CN); Kai LI, Dalian (CN); Zhen ZHANG, Dalian (CN); Yongqing WANG, Dalian (CN)

(21) Appl. No.: 19/695,384

(22) Filed: Jun. 2, 2026

Related U.S. Application Data
(63) Continuation of application No. PCT/CN2025/129722, filed on Oct. 24, 2025.

(30) Foreign Application Priority Data
Apr. 18, 2025 (CN) 202510488874.4

(51) Int. Cl. G01M 99/00

(52) U.S. Cl. CPC G01M 99/005

(57) ABSTRACT

The present invention discloses an accelerated test device and a use method for accuracy retentivity of machine tool rotation axis components. The test device comprises a stress loading part and a functional component installation part; the stress loading part comprises a follow-up static/dynamic force loading device, a high-low temperature loading device, and a vibration exciter, which can simultaneously satisfy the cyclic loading needs of three-directional static/dynamic forces, vibration loads, and temperature loads for three different types of functional components of a spindle, a swivel head, and a tilting rotary table; the functional component installation part is composed of a universal swivel head and spindle installation device and a special tilting rotary table installation device, and by simply replacing the installation devices, the rapid installation of three different types of machine tool rotation axis functional components of the spindle, the swivel head, and the tilting rotary table can be achieved.

### TECHNICAL FIELD

The present invention belongs to the technical field of performance testing of functional components, and relates to an accelerated test device and a use method for accuracy retentivity of machine tool rotation axis components.

### BACKGROUND

Computer numerical control machine tools are the cornerstone of industrial modernization and the key manufacturing equipment for the development of high-end equipment such as aerospace, war industry, and automobiles, etc., and have an important strategic position. A swivel head, a tilting rotary table and a spindle are the key rotation axis functional components of a CNC machine tool, and play a decisive role in the machining quality of parts. The accuracy retentivity is one of the key performance indexes of the rotation axis functional components, and describes the ability of the rotation axis functional components to maintain the original accuracy under normal use conditions. The decline in the accuracy retentivity of the rotation axis functional components will lead to a reduction in the machining accuracy of machining equipment, thereby affecting the overall performance and stability of the equipment. Therefore, the research on the accuracy retentivity of the rotation axis functional components has important theoretical and practical significance.

The traditional test methods for the accuracy retentivity of the rotation axis functional components mainly rely on on-site tracking tests, with a time span of several months or even years, thereby resulting in low test efficiency. At present, with the development of the accelerated test technology, some accelerated test devices for accuracy retentivity of rotation axis functional components have been proposed. In 2014, Jing Guofeng, et al. from Yantai Universal Machine Tool Accessory Group Co., Ltd. disclosed a detection device for accuracy retentivity of a rotary table in patent CN104020716A. This device simulates an actual cutting load through a magnetic powder brake to apply a torque to a tested rotary table, which replaces the loading mode of adding heavy objects to the rotary table, thereby accelerating the accuracy degradation process of the rotary table and increasing the detection efficiency of accuracy retentivity of the rotary table to a certain extent. In 2018, Pan Shaogang, et al. from Yantai Universal Machine Tool Equipment Co., Ltd. disclosed an experimental loading device for accuracy retentivity of a rotary table in patent CN206862661U. This device uses a damping moment generated by a friction disc to load the rotary table, which provides a smaller change in the loading moment and a wider moment adjustment range compared with the magnetic powder brake. In 2024, Wang Zhi, et al. from Dalian University of Technology disclosed a method for testing and assessing electric spindle accuracy characteristics based on dynamic vector force loading in patent CN118067517A. This method achieves the detection of the electric spindle accuracy characteristics by applying moment and dynamic vector forces to an electric spindle.

The above research indicates that the accelerated test technology achieves excellent application in the field of functional component performance testing. However, the following problems still exist: (1) the existing test devices are mostly used for the spindle and the rotary table, and test devices for accuracy retentivity of the swivel head and the tilting rotary table are lacked; (2) the spindle, the tilting rotary table and the swivel head face similar load environments during actual service, and there are commonalities in the needs for the test device. However, most of the existing test devices are special devices and can only test the same type of rotation axis functional components. There is no universal accelerated test device for accuracy retentivity of rotation axis functional components capable of uniformly covering the three types of the swivel head, the tilting rotary table, and the spindle; (3) the existing test device for accuracy retentivity of rotation axis functional components only applies static/dynamic forces or moments during loading, without taking into account the effects caused by vibration and temperature changes on the degradation of equipment accuracy.

### SUMMARY

The purpose of the present invention is to provide an accelerated test device for accuracy retentivity of machine tool rotation axis components, which is used for solving the problems of the scarcity of the accelerated test device for accuracy retentivity of machine tool rotation axis functional components and the difficulty in acquiring accuracy degradation data. By simply replacing tooling fixtures, performance tests of different types of rotation axis functional components can be completed, and the accuracy degradation data of key functional components of machine tools can be quickly acquired to support the iterative upgrading of domestic key functional components.

The technical solution of the present invention is as follows:

An accelerated test device for accuracy retentivity of machine tool rotation axis components comprises a stress loading part and a functional component installation part; the stress loading part comprises a follow-up static/dynamic force loading device 1, a high-low temperature loading device 2, and a vibration exciter 3, which simultaneously satisfy the cyclic loading needs of three-directional static/dynamic forces, vibration loads, and temperature loads for three different types of functional components of a spindle, a swivel head, and a tilting rotary table; the functional component installation part comprises a universal swivel head and spindle installation device 4 and a special tilting rotary table installation device 5, and by replacing the installation devices, the rapid installation of three different types of machine tool rotation axis functional components of the spindle, the swivel head, and the tilting rotary table is achieved.

Further, the follow-up static/dynamic force loading device 1 is mainly composed of a follow-up device and a loading device.

Further, the follow-up device comprises a support seat 101, support seat guide rails 102, an arc-shaped guide rail 103, an arc-shaped rack 104, a follow-up sliding plate 105, a rack 106, and a speed-reduction motor 107; wherein the support seat 101 is installed on the support seat guide rails 102, two support seat guide rails 102 are provided, the rack 106 parallel to the support seat guide rails is arranged beside the support seat guide rails 102, and the rack 106 cooperates with a cylindrical gear at the bottom of the support seat 101 and is driven by the speed-reduction motor 107 so that the support seat 101 moves along the support seat guide rails 102 and a position is adaptively adjusted according to the size of a tested functional component; the bottom of the follow-up sliding plate 105 is provided with a tooling rotary table 108, which is fixedly connected with the loading device, and the rotational speed of the tooling rotary table 108 is adaptively adjusted according to the loading needs of the rotary table in the tilting rotary table to drive the loading device to achieve rotational following; the arc-shaped guide rail 103 and the arc-shaped rack 104 are fixed to the support seat 101, and cooperate with a guide rail slider 109 at the top of the follow-up sliding plate 105 and the cylindrical gear 110 respectively, and the follow-up sliding plate speed-reduction motor 111 on the follow-up sliding plate 105 is driven to drive the loading device to perform circular motion along the arc-shaped guide rail 103, to ensure that the loading device is always maintained in a constant relative position during the swing of the tilting rotary table and the swivel head, thereby achieving follow-up loading.

Further, the loading device comprises a connecting block 112, a connecting plate 113, eccentric wheel loading mechanisms 114, tension and compression sensors 115, a loading support plate 116, and a triaxial force sensor 117; wherein the connecting block 112 is connected with the tooling rotary table 108 at the bottom of the follow-up sliding plate 105 through a bolt; the tops of the three eccentric wheel loading mechanisms 114 are uniformly fixed around the connecting block 112 through the connecting plate 113; the bottoms of the eccentric wheel loading mechanisms 114 are connected with the loading support plate 116 through the tension and compression sensors 115; the bottom of the loading support plate 116 is placed on the universal swivel head and spindle installation device 4 or the special tilting rotary table installation device 5 for the connection between the tested functional component and the loading device; three forces in different directions are applied to the tested functional component through the three eccentric wheel loading mechanisms to achieve three-directional static/dynamic force loading on the tested functional component; the triaxial force sensor 117 is arranged inside the loading support plate 116 and is used for monitoring the sizes of the three-directional static and dynamic forces on the tested functional component; and the tension and compression sensors 115 are used for monitoring the sizes of the static and dynamic forces outputted by the eccentric wheel loading mechanisms 114.

Further, the high-low temperature loading device 2 is an environmental chamber, and an interior thereof is used for installing the functional component; the top and a side surface of the environmental chamber are provided with a chamber door respectively; the tested functional component is put into the high-low temperature loading device 2 through the chamber door at the top; an operator performs assembly and debugging work from the chamber door on the side surface; and when the chamber doors of the high-low temperature loading device 2 are all closed, the high-low temperature loading device 2 applies cold and hot air to the interior through an internal blower nozzle to cause periodic changes in the temperature of an internal space.

Further, the universal swivel head and spindle installation device 4 comprises a rotary table 401, an installation bracket 402, an installation box and a simulated toolholder 405; wherein the bottom of the rotary table 401 is fixed to an upper surface of the vibration exciter 3, and the upper surface thereof is connected with the installation bracket 402; the installation box is divided into a swivel head installation box 403 and a spindle installation box 404, which are designed to hold the swivel head and the spindle respectively and are not used concurrently, and one is selected and placed on the installation bracket 402 according to the loading needs; the bottom of the simulated toolholder 405 cooperates with the swivel head or the spindle, and the top is connected with the loading support plate 116.

Further, the special tilting rotary table installation device 5 comprises bases 501, tilting rotary table installation brackets 502, and a loading block 503; wherein the bases 501 are fixedly connected with the vibration exciter 3 through bolts; the bottoms of the tilting rotary table installation brackets 502 are connected with the bases 501; the tilting rotary table is placed at the tops; the tilting rotary table installation brackets 502 are provided with shim blocks 504; the installation height of the tilting rotary table is adjusted by replacing the shim blocks 504; a ball screw 505 is arranged between the two tilting rotary table installation brackets 502, and the ball screw 505 is rotated according to the size of the tilting rotary table to adjust the widths of the tilting rotary table installation brackets 502; and the top of the loading block 503 is connected with the loading support plate 116, and the bottom of the loading block is fixedly connected with a rotary table plane of the tilting rotary table through a bolt.

A method for testing using the accelerated test device for accuracy retentivity of machine tool rotation axis components comprises the following steps:
a use method when loading the swivel head or the spindle comprises:
(1) fixing the rotary table 401 to the upper surface of the vibration exciter 3, placing the installation bracket 402 above the rotary table 401, and placing the swivel head installation box 403 or the spindle installation box 404 on the installation bracket 402 according to the loading needs;
(2) opening the chamber door at the top of the high-low temperature loading device 2, placing the swivel head on the swivel head installation box 403 by using a crane, locking with bolts and at the same time, placing the simulated toolholder 405 on the swivel head; or placing the spindle on the spindle installation box 404 by using the crane, locking with a bolt, and at the same time, placing the simulated toolholder 405 on the spindle;
(3) driving the follow-up static/dynamic force loading device 1 to move along the support seat guide rails 102 to a place above the swivel head or the spindle; at the same time, driving the follow-up sliding plate speed-reduction motor 111 inside the follow-up sliding plate 105 to rotate, to drive the arc-shaped rack 104 for transmission; causing the loading device to move along the arc-shaped guide rail 103 until the triaxial force sensor 117 inside the loading support plate 116 in the loading device is coaxial with the simulated toolholder 405; and then fixedly connecting the loading support plate 116 with the simulated toolholder 405 by using bolts, so that the loading support plate 116 is firmly placed on the swivel head or the spindle;
(4) closing all the chamber doors of the high-low temperature loading device 2 and starting a test.

Further, a use method when loading the tilting rotary table comprises:
(1) connecting lower surfaces of the bases 501 with the upper surface of the vibration exciter 3 through bolts; at the same time, placing the tilting rotary table installation brackets 502 on upper surfaces of the bases 501, and selecting shim blocks 504 of appropriate thicknesses according to the size of the tilting rotary table; and adjusting the installation brackets to appropriate widths through the ball screw 505 inside the tilting rotary table installation brackets 502;
(2) opening the chamber door at the top of the high-low temperature loading device 2, placing the tilting rotary table on the tilting rotary table installation bracket 502 through a crane, and placing the loading block 503 on the rotary table of the tilting rotary table and fixedly connecting the loading block with a bolt;
(3) driving the follow-up static/dynamic force loading device 1 to move along the support seat guide rails 102 to a place above the tilting rotary table; at the same time, driving the follow-up sliding plate speed-reduction motor 111 inside the follow-up sliding plate 105 to rotate, to drive the arc-shaped rack 104; causing the loading device to move along the arc-shaped guide rail 103 until a lower surface of the loading support plate 116 in the loading device is parallel to an upper surface of the loading block 503; and then fixedly connecting the loading support plate 116 with the loading block 503 by using bolts, so that the loading support plate 116 is firmly placed on the tilting rotary table;
(4) closing all the chamber doors of the high-low temperature loading device 2 and starting a test.

The present invention has the following beneficial effects:
(1) The spindle, the tilting rotary table and the swivel head face similar load environments during actual service, and there are commonalities in the needs for the test device. However, most of the existing test devices are special devices and can only test the same type of rotation axis functional components. The accelerated test device for accuracy retentivity of machine tool rotation axis functional components proposed by the present invention can complete accelerated tests of accuracy retentivity of three types of rotation axis functional components of the spindle, the swivel head and the tilting rotary table by simply replacing the installation devices, thereby solving the problems of single test object and poor universality in the current accelerated test device for accuracy retentivity of machine tool rotation axis functional components and filling the gap of the domestic and foreign universal accelerated test devices for accuracy retentivity of machine tool rotation axis functional components.
(2) The accelerated test device for accuracy retentivity of machine tool rotation axis functional components proposed by the present invention can simultaneously load multiple stresses such as vibration, static/dynamic forces, and temperature, which is more in line with the actual service conditions of various types of functional components and can provide a scientific basis for the iterative optimization of the rotation axis functional components of domestic industrial machine tools.

### DESCRIPTION OF DRAWINGS

FIG. 1 is a schematic diagram of loading of a swivel head of an accelerated test device for accuracy retentivity of machine tool rotation axis functional components in the present invention.

FIG. 2 is a schematic diagram of spindle loading of an accelerated test device for accuracy retentivity of machine tool rotation axis functional components in the present invention.

FIG. 3 is a schematic diagram of loading of a tilting rotary table of an accelerated test device for accuracy retentivity of machine tool rotation axis functional components in the present invention.

FIG. 4 is a structural schematic diagram of a follow-up static/dynamic force loading device; (a) structural schematic diagram of a follow-up device, (b) structural schematic diagram of a follow-up sliding plate, and (c) structural schematic diagram of a loading device.

FIG. 5 is a structural schematic diagram of a universal swivel head and spindle installation device.

FIG. 6 is a structural schematic diagram of a special tilting rotary table installation device.

In the figures: 1 follow-up static/dynamic force loading device; 2 high-low temperature loading device; 3 vibration exciter; 4 universal swivel head and spindle installation device; 5 special tilting rotary table installation device; 101 support seat; 102 support seat guide rail; 103 arc-shaped guide rail; 104 arc-shaped rack; 105 follow-up sliding plate; 106 rack; 107 speed-reduction motor; 108 tooling rotary table; 109 guide rail slider; 110 cylindrical gear; 111 follow-up sliding plate speed-reduction motor; 112 connecting block; 113 connecting plate; 114 eccentric wheel loading mechanism; 115 tension and compression sensor; 116 loading support plate; 117 triaxial force sensor; 401 rotary table; 402 installation bracket; 403 swivel head installation box; 404 spindle installation box; 405 simulated toolholder; 501 base; 502 tilting rotary table installation bracket; 503 loading block; 504 shim block; 505 ball screw.

### DETAILED DESCRIPTION

Detailed description of the present invention is described below in detail in combination with drawings and the technical solution.

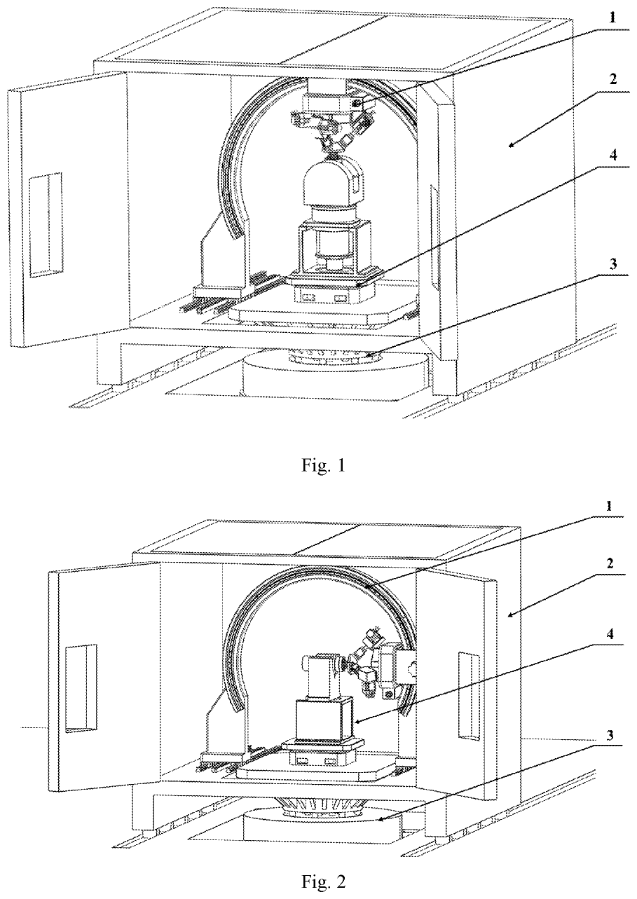

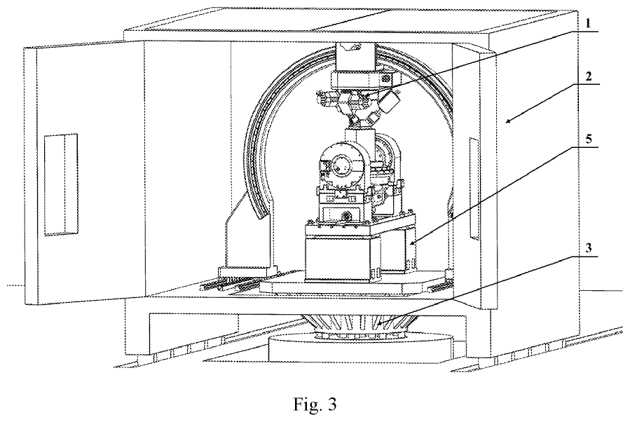

As shown in FIGS. 1-3, an accelerated test device for accuracy retentivity of machine tool rotation axis components comprises a stress loading part and a functional component installation part; the stress loading part comprises a follow-up static/dynamic force loading device 1, a high-low temperature loading device 2, and a vibration exciter 3, which can simultaneously satisfy the cyclic loading needs of three-directional static/dynamic forces, vibration loads, and temperature loads for three different types of functional components of a spindle, a swivel head, and a tilting rotary table; the functional component installation part comprises a universal swivel head and spindle installation device 4 and a special tilting rotary table installation device 5, and by simply replacing the installation devices, the rapid installation of three different types of machine tool rotation axis functional components of the spindle, the swivel head, and the tilting rotary table can be achieved.

The follow-up static/dynamic force loading device 1 is composed of a follow-up device and a loading device.

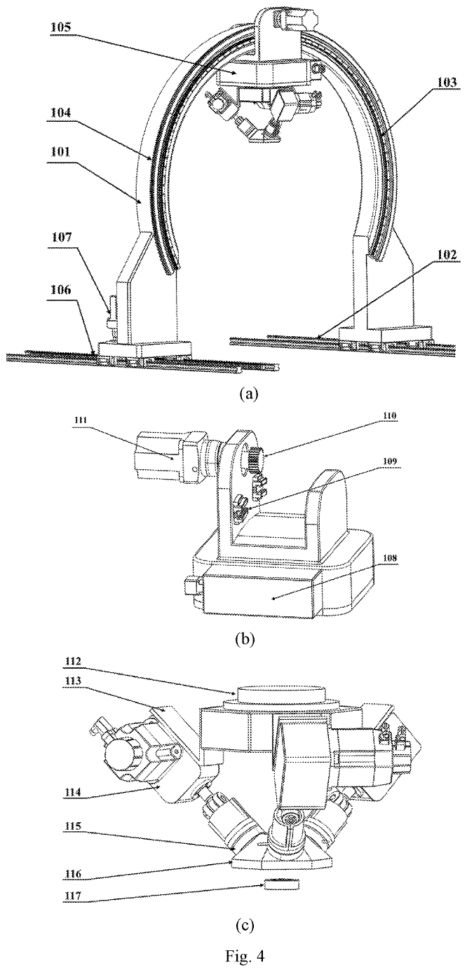

As shown in FIG. 4(a), the follow-up device comprises a support seat 101, support seat guide rails 102, an arc-shaped guide rail 103, an arc-shaped rack 104, a follow-up sliding plate 105, a rack 106, and a speed-reduction motor 107; wherein the support seat 101 is installed on the support seat guide rails 102, the rack 106 parallel to the support seat guide rails is arranged beside the support seat guide rails 102, and the rack 106 cooperates with a cylindrical gear at the bottom of the support seat 101 and is driven by the speed-reduction motor 107 so that the support seat 101 can freely move along the direction of the guide rails and the own position is adaptively adjusted according to the size of a tested functional component; as shown in FIG. 4(b), the bottom of the follow-up sliding plate 105 is provided with a tooling rotary table 108, which is fixedly connected with the loading device, and the rotational speed of the tooling rotary table 108 is adaptively adjusted according to the loading needs of the rotary table in the tilting rotary table to drive the loading device to achieve rotational following; the arc-shaped guide rail 103 and the arc-shaped rack 104 are fixed to the support seat 101 through bolts, and cooperate with a guide rail slider 109 at the top of the follow-up sliding plate 105 and the cylindrical gear 110 respectively, and the follow-up sliding plate speed-reduction motor 111 in the follow-up sliding plate 105 is driven to drive the loading device to perform circular motion along the arc-shaped guide rail 103, to ensure that the loading device is always maintained in a constant relative position during the swing of the tilting rotary table and the swivel head, thereby achieving follow-up loading.

As shown in FIG. 4(c), the loading device comprises a connecting block 112, a connecting plate 113, eccentric wheel loading mechanisms 114, tension and compression sensors 115, a loading support plate 116, and a triaxial force sensor 117; wherein the connecting block 112 is connected with the tooling rotary table 108 at the bottom of the follow-up sliding plate 105 through a bolt; the tops of the three eccentric wheel loading mechanisms 114 are distributed and placed around the connecting block 112 through the connecting plate 113; the bottoms of the eccentric wheel loading mechanisms are connected with the loading support plate 116 through the tension and compression sensors 115; the bottom of the loading support plate 116 is placed on the universal swivel head and spindle installation device 4 or the special tilting rotary table installation device 5 for the connection between the tested functional component and the loading device; three forces in different directions are applied to the tested functional component through the three eccentric wheel loading mechanisms 114 to achieve three-directional static/dynamic force loading on the tested functional component; the triaxial force sensor 117 is arranged inside the loading support plate 116 and is used for monitoring the sizes of the three-directional static/dynamic forces on the tested functional component; and the tension and compression sensor 115 placed at the bottom of each eccentric wheel loading mechanism 114 is used for monitoring the sizes of the static/dynamic forces outputted by the eccentric wheel loading mechanisms 114.

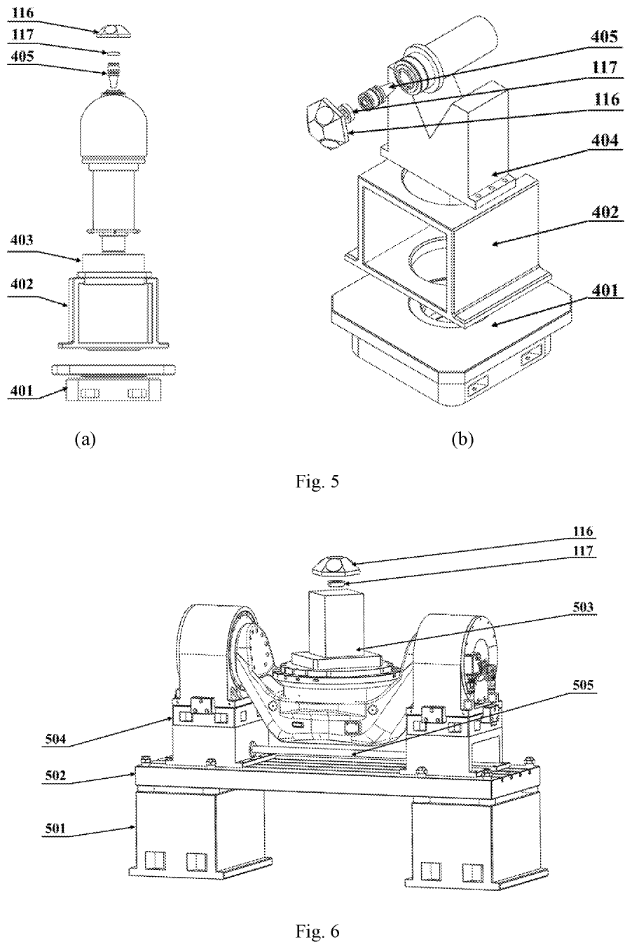

As shown in FIG. 5, the universal swivel head and spindle installation device 4 comprises a rotary table 401, an installation bracket 402, a swivel head installation box 403, a spindle installation box 404, and a simulated toolholder 405; wherein one side of the rotary table 401 is fixed to an upper surface of the vibration exciter 3, and the other side is connected with the installation bracket 402 through a bolt; the swivel head installation box 403 and the spindle installation box 404 are designed to hold the swivel head and the spindle respectively, the swivel head installation box 403 and the spindle installation box 404 are not used concurrently and one is selected and placed on the installation bracket 402 according to the loading needs; the bottom of the simulated toolholder 405 cooperates with the swivel head or the spindle, and the top is connected with the loading support plate 116.

As shown in FIG. 6, the special tilting rotary table installation device 5 comprises bases 501, tilting rotary table installation brackets 502, and a loading block 503; wherein the bases 501 are fixedly connected with the vibration exciter 3 through bolts; the bottoms of the tilting rotary table installation brackets 502 are connected with the bases 501; the tilting rotary table is placed at the tops; the tilting rotary table installation brackets 502 are provided with shim blocks 504; the installation height of the tilting rotary table can be adjusted by replacing the shim blocks 504; meanwhile, a ball screw 505 is arranged between the two tilting rotary table installation brackets, and the ball screw 505 is rotated according to the size of the tilting rotary table to adjust the widths of the tilting rotary table installation brackets; and the top of the loading block 503 is connected with the loading support plate 116, and the bottom of the loading block is fixedly connected with a rotary table plane of the tilting rotary table through a bolt.

### Embodiment 1

The present embodiment takes a certain model of swivel head and a certain model of tilting rotary table as examples to describe the device and the use method in detail:

The gross weight of the swivel head is 1150 kg, with overall dimensions of 685*685*1409 mm; the spindle torque is 318 Nm, the maximum rotational speed is 7000 rpm, and the rotation range of the A-axis is ±105°. The gross weight of the swivel head is 2400 kg, with overall dimensions of 2209*325*635 mm; the maximum rotational speed of the C-axis is 100 rpm; the swing range of the A-axis is ±120°, and the maximum rotational speed is 50 rpm.

Before a test is started, as shown in FIG. 1, the rotary table 401 is fixed to the upper surface of the vibration exciter 3; the installation bracket 402 is placed above the rotary table 401; the swivel head installation box 403 is placed on the installation bracket 402; then, the chamber door at the top of the high-low temperature loading device 2 is opened; the swivel head is placed on the swivel head installation box 403 through a crane and locked with a bolt; at the same time, the simulated toolholder 405 is placed on the swivel head; the follow-up static/dynamic force loading device 1 is driven to move along the support seat guide rails 102 to a place above the swivel head; at the same time, the follow-up sliding plate speed-reduction motor 111 inside the follow-up sliding plate 105 is driven to rotate, to drive the arc-shaped rack 104 for transmission; the loading device is caused to move along the arc-shaped guide rail 103 until the triaxial force sensor 117 inside the loading support plate 116 in the loading device is coaxial with the simulated toolholder 405; and then the loading support plate 116 is fixedly connected with the simulated toolholder 405 by using bolts, so that the loading support plate 116 is firmly placed on the swivel head; and finally, all the chamber doors of the high-low temperature loading device 2 are closed and the test is started.

In the process of the test, the vibration exciter 3 is started, the vibration amplitude is set to 1 mm, and the vibration frequency is set to 65 Hz; the high-low temperature loading device 2 is started, and the circulating temperature range is set to −20 °C to 60 °C; a tested swivel head is started, the rotational speed of the spindle of the swivel head is set to 3000 rpm, and the swing speed of the A-axis is set to 105°/min; the rotary table 401 is started, and the rotational speed of the rotary table is set to 10 rpm; and the C-axis of the swivel head is driven to rotate to ensure that the loading conditions are more in line with the actual working conditions, so that all positions of the swivel head can be loaded; the follow-up static/dynamic force loading device 1 is started; the feed speed of the follow-up sliding plate 105 is set to 105°/min to perform follow-up following on the swing of the A-axis of the swivel head; the three eccentric wheel loading mechanisms 114 are driven to simultaneously apply a dynamic force of 200 N in three directions of X/Y/Z of the swivel head, with a force change frequency of 30 Hz; after the “thermal-vibration-dynamic force” combination is continuously loaded for 120 min, the vibration exciter 3, the high-low temperature loading device 2, and the follow-up static/dynamic force loading device 1 are closed; the movement of the swivel head is stopped; the accuracy degradation data of the system is tested and recorded; the above process is circulated until the loading time reaches 150 h; and the loading process of the spindle is similar to the above steps, and will not be described in detail.

After the loading of the swivel head is completed, the loading device is disconnected from the swivel head; the follow-up static/dynamic force loading device 1 is driven away from the swivel head; the chamber door at the top of the high-low temperature loading device 2 is opened; the swivel head is moved away from the swivel head installation box 403 by using a crane, and the universal swivel head and spindle installation device 4 is removed.

Then, as shown in FIG. 3, the lower surfaces of the bases 501 are connected with the upper surface of the vibration exciter 3 through bolts; at the same time, the tilting rotary table installation brackets 502 are placed on the upper surfaces of the bases 501, and a shim block 504 with a height of 300 mm is selected according to the size of the tilting rotary table for adjusting the installation height of the tilting rotary table, and the length of the installation bracket is adjusted to 2300 mm through the ball screw 505 inside the tilting rotary table installation bracket 502 to adapt to the size of the tilting rotary table; then, the chamber door at the top of the high-low temperature loading device 2 is opened, the tilting rotary table is placed on the tilting rotary table installation bracket 502 through the crane, and the loading block 503 is placed on the rotary table of the tilting rotary table and fixedly connected through a bolt; then, the follow-up static/dynamic force loading device 1 is driven to move along the support seat guide rails 102 to a place above the tilting rotary table; at the same time, the follow-up sliding plate speed-reduction motor 111 inside the follow-up sliding plate 105 is driven to rotate, to drive the internal arc-shaped rack 104; the loading device is caused to move along the arc-shaped guide rail 103 until the lower surface of the loading support plate 116 in the loading device is parallel to the upper surface of the loading block 503; and then the loading support plate 116 is fixedly connected with the loading block 503 by using bolts, so that the loading support plate 116 is firmly placed on the tilting rotary table; and finally, all the chamber doors of the high-low temperature loading device 2 are closed and the test is started.

In the process of the test, the vibration exciter 3 is started, the vibration amplitude is set to 0.5 mm, and the vibration frequency is set to 65 Hz; the high-low temperature loading device 2 is started, and the circulating temperature range is set to −20 °C to 60 °C; the tested tilting rotary table is started, the rotational speed of the C-axis of the tilting rotary table is set to 30 rpm, and the rotational speed of the A-axis is set to 500°/min; the follow-up static/dynamic force loading device 1 is started; the feed speed of the follow-up sliding plate 105 is set to 500°/min to perform follow-up following on the swing of the A-axis of the tilting rotary table; at the same time, the rotational speed of the tooling rotary table 108 at the bottom of the follow-up sliding plate is set to 30 rpm to perform rotational following on the C-axis of the tilting rotary table; the three eccentric wheel loading mechanisms 114 are driven to simultaneously apply a dynamic force of 300 N in three directions of X/Y/Z of the swivel head, with a force change frequency of 30 Hz; after the “thermal-vibration-dynamic force” combination is continuously loaded for 120 min, the vibration exciter 3, the high-low temperature loading device 2, and the follow-up static/dynamic force loading device 1 are closed; the movement of the tilting rotary table is stopped; the accuracy degradation data of the tilting rotary table is tested and recorded; and the above process is circulated until the loading time reaches 150 h.

1. An accelerated test device for accuracy retentivity of machine tool rotation axis components, comprising a stress loading part and a functional component installation part, wherein the stress loading part comprises a follow-up static/dynamic force loading device, a high-low temperature loading device, and a vibration exciter, which simultaneously satisfy the cyclic loading needs of three-directional static/dynamic forces, vibration loads, and temperature loads for three different types of functional components of a spindle, a swivel head, and a tilting rotary table; the functional component installation part comprises a universal swivel head and spindle installation device and a special tilting rotary table installation device, and by replacing the installation devices, the rapid installation of three different types of machine tool rotation axis functional components of the spindle, the swivel head, and the tilting rotary table is achieved;
the follow-up static/dynamic force loading device is mainly composed of a follow-up device and a loading device;
the follow-up device comprises a support seat, support seat guide rails, an arc-shaped guide rail, an arc-shaped rack, a follow-up sliding plate, a rack, and a speed-reduction motor; wherein the support seat is installed on the support seat guide rails, two support seat guide rails are provided, the rack parallel to the support seat guide rails is arranged beside the support seat guide rails, and the rack cooperates with a cylindrical gear at the bottom of the support seat and is driven by the speed-reduction motor so that the support seat is driven to move along the support seat guide rails and a position is adaptively adjusted according to the size of a tested functional component; the bottom of the follow-up sliding plate is provided with a tooling rotary table, which is fixedly connected with the loading device, and the rotational speed of the tooling rotary table is adaptively adjusted according to the loading needs of the rotary table in the tilting rotary table to drive the loading device to achieve rotational following; the arc-shaped guide rail and the arc-shaped rack are fixed to the support seat, and cooperate with a guide rail slider at the top of the follow-up sliding plate and the cylindrical gear respectively, and the follow-up sliding plate speed-reduction motor on the follow-up sliding plate is driven to drive the loading device to perform circular motion along the arc-shaped guide rail, to ensure that the loading device is always maintained in a constant relative position during the swing of the tilting rotary table and the swivel head, thereby achieving follow-up loading.

2. The accelerated test device for accuracy retentivity of machine tool rotation axis components according to claim 1, wherein the loading device comprises a connecting block, a connecting plate, eccentric wheel loading mechanisms, tension and compression sensors, a loading support plate, and a triaxial force sensor; wherein the connecting block is connected with the tooling rotary table at the bottom of the follow-up sliding plate through bolts; the tops of the three eccentric wheel loading mechanisms are uniformly fixed around the connecting block through the connecting plate; the bottoms of the eccentric wheel loading mechanisms are connected with the loading support plate through the tension and compression sensors; the bottom of the loading support plate is placed on the universal swivel head and spindle installation device or the special tilting rotary table installation device for the connection between the tested functional component and the loading device; three forces in different directions are applied to the tested functional component through the three eccentric wheel loading mechanisms to achieve three-directional static/dynamic force loading on the tested functional component; the triaxial force sensor is arranged inside the loading support plate and is used for monitoring the sizes of the three-directional static and dynamic forces on the tested functional component; and the tension and compression sensors are used for monitoring the sizes of the static and dynamic forces outputted by the eccentric wheel loading mechanisms.

3. The accelerated test device for accuracy retentivity of machine tool rotation axis components according to claim 1, wherein the high-low temperature loading device is an environmental chamber, and an interior thereof is used for installing the functional component; the top and a side surface of the environmental chamber are provided with a chamber door respectively; the tested functional component is put into the high-low temperature loading device through the chamber door at the top; an operator performs assembly and debugging work from the chamber door on the side surface; and when the chamber doors of the high-low temperature loading device are all closed, the high-low temperature loading device applies cold and hot air to the interior through an internal blower nozzle to cause periodic changes in the temperature of an internal space.

4. The accelerated test device for accuracy retentivity of machine tool rotation axis components according to claim 1, wherein the universal swivel head and spindle installation device comprises a rotary table, an installation bracket, an installation box and a simulated toolholder; wherein the bottom of the rotary table is fixed to an upper surface of the vibration exciter, and the upper surface thereof is connected with the installation bracket; the installation box is divided into a swivel head installation box and a spindle installation box, which are designed to hold the swivel head and the spindle respectively and are not used concurrently, and one is selected and placed on the installation bracket according to the loading needs; the bottom of the simulated toolholder cooperates with the swivel head or the spindle, and the top is connected with the loading support plate.

5. The accelerated test device for accuracy retentivity of machine tool rotation axis components according to claim 1, wherein the special tilting rotary table installation device comprises bases, tilting rotary table installation brackets, and a loading block; wherein the bases are fixedly connected with the vibration exciter through bolts; the bottoms of the tilting rotary table installation brackets are connected with the bases; the tilting rotary table is placed at the tops; the tilting rotary table installation brackets are provided with shim blocks; the installation height of the tilting rotary table is adjusted by replacing the shim blocks; a ball screw is arranged between the two tilting rotary table installation brackets, and the ball screw is rotated according to the size of the tilting rotary table to adjust the spacing between the tilting rotary table installation brackets; and the top of the loading block is connected with the loading support plate, and the bottom of the loading block is fixedly connected with a rotary table plane of the tilting rotary table through bolts.

6. A method for testing using the accelerated test device for accuracy retentivity of machine tool rotation axis components according to claim 1, comprising the following steps:
a use method when loading the swivel head or the spindle comprises:
fixing the rotary table to the upper surface of the vibration exciter, placing the installation bracket above the rotary table, and placing the swivel head installation box or the spindle installation box on the installation bracket according to the loading needs;
opening the chamber door at the top of the high-low temperature loading device, placing the swivel head on the swivel head installation box by using a crane, locking with bolts and at the same time, placing the simulated toolholder on the swivel head; or placing the spindle on the spindle installation box by using the crane, locking with bolts, and at the same time, placing the simulated toolholder on the spindle;
driving the follow-up static/dynamic force loading device to move along the support seat guide rails to above the swivel head or the spindle; at the same time, driving the follow-up sliding plate speed-reduction motor inside the follow-up sliding plate to rotate, to drive the arc-shaped rack for transmission; causing the loading device to move along the arc-shaped guide rail until the triaxial force sensor inside the loading support plate in the loading device is coaxial with the simulated toolholder; and then fixedly connecting the loading support plate with the simulated toolholder by using bolts, so that the loading support plate is firmly placed on the swivel head or the spindle;
closing all the chamber doors of the high-low temperature loading device and starting a test.

7. A method for testing using the accelerated test device for accuracy retentivity of machine tool rotation axis components according to claim 1, comprising the following steps:
a use method when loading the tilting rotary table comprises:
connecting lower surfaces of the bases with the upper surface of the vibration exciter through bolts; at the same time, placing the tilting rotary table installation brackets on upper surfaces of the bases, and selecting shim blocks of appropriate thicknesses according to the size of the tilting rotary table; and adjusting the installation brackets to appropriate widths through the ball screw inside the CNC tilting rotary table installation brackets;
opening the chamber door at the top of the high-low temperature loading device, placing the tilting rotary table on the tilting rotary table installation bracket through a crane, and placing the loading block (503) on the rotary table of the tilting rotary table and fixedly connecting the loading block with bolts;
driving the follow-up static/dynamic force loading device to move along the support seat guide rails to above the tilting rotary table; at the same time, driving the follow-up sliding plate speed-reduction motor inside the follow-up sliding plate to rotate, to drive the arc-shaped rack; causing the loading device to move along the arc-shaped guide rail until a lower surface of the loading support plate in the loading device is parallel to an upper surface of the loading block; and then fixedly connecting the loading support plate with the loading block by using bolts, so that the loading support plate is firmly placed on the tilting rotary table;
closing all the chamber doors of the high-low temperature loading device and starting a test.
